(19) United States
(12) Patent Application Publication
(10) Pub. No.: US 2019/0303212 A1
(43) Pub. Date: Oct. 3, 2019

(54) METHOD FOR MANAGING APPLICATION CONFIGURATION STATE WITH CLOUD BASED APPLICATION MANAGEMENT TECHNIQUES

(71) Applicant: Cisco Technology, Inc., San Jose, CA (US)

(72) Inventors: Hendrikus GP Bosch, Aalsmeer (NL); Alessandro Duminuco, Milano (IT); Baton Daullxhi, Los Altos, CA (US)

(21) Appl. No.: 16/294,861

(22) Filed: Mar. 6, 2019

Related U.S. Application Data
(60) Provisional application No. 62/650,949, filed on Mar. 30, 2018.

(51) Int. Cl. G06F 9/50; G06F 16/9035; G06F 9/455; H04L 29/06; H04L 29/08

(52) U.S. Cl. CPC G06F 9/5077; G06F 16/9035; G06F 9/45558; G06F 2009/45595; H04L 63/0227; H04L 67/1097; H04L 63/0218

(57) ABSTRACT

In an embodiment, a computer-implemented method is presented for updating a configuration of a deployed application, the method comprising: receiving a request to update an application profile model hosted in a database, the request specifying a change of a first set of application configuration parameters of the deployed application to a second set of application configuration parameters, the first set of application configuration parameters indicating a current configuration state of the deployed application and the second set of application configuration parameters indicating a target configuration state of the deployed application, in response to the request, updating the application profile model using the second set of application configuration parameters, and generating, based on the updated application profile model, a solution descriptor comprising a description of the first set of application configuration parameters and the second set of application configuration parameters, and updating the deployed application based on the solution descriptor.

### BENEFIT CLAIM

This application claims the benefit under 35 U.S.C. § 119(e) of provisional application 62/650,949, filed Mar. 30, 2018, the entire contents of which are hereby incorporated by reference for all purposes as if fully set forth herein.

### TECHNICAL FIELD

The technical field of the present disclosure generally relates to improved methods, computer software, and/or computer hardware in virtual computing centers or cloud computing environments. Another technical field is computer-implemented techniques for managing cloud applications and cloud application configuration.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

Many computing environments or infrastructures provide for shared access to pools of configurable resources (such as compute services, storage, applications, networking devices, etc.) over a communications network. One type of such a computing environment may be referred to as a cloud computing environment. Cloud computing environments allow users, and enterprises, with various computing capabilities to store and process data in either a privately owned cloud or on a publicly available cloud in order to make data accessing mechanisms more efficient and reliable. Through the cloud environments, software applications or services may be distributed across the various cloud resources in a manner that improves the accessibility and use of such applications and services for users of the cloud environments.

Operators of cloud computing environments often host many different applications from many different tenants or clients. For example, a first tenant may utilize the cloud environment and the underlying resources and/or devices for data hosting while another client may utilize the cloud resources for networking functions. In general, each client may configure the cloud environment for their specific application needs. Deployment of distributed applications may occur through an application or cloud orchestrator. Thus, the orchestrator may receive specifications or other application information and determine which cloud services and/or components are utilized by the received application. The decision process of how an application is distributed may utilize any number of processes and/or resources available to the orchestrator.

For deployed distributed applications, updating a single instance of an application can be managed as a manual task, yet, consistently maintaining a large set of application configuration parameters is a challenge. Consider, for instance, a distributed firewall deployed with many different policy rules. To update these rules consistently and across all instances of a deployed firewall, it is important to reach each and every instance of the distributed firewall, to (a) retract rules that have been taken out of commission, (b) update rules that have been changed and (c) install new rules if so needed. As such changes are realized, network partitions and application and/or other system failures can disrupt such updates. For other applications, the similar challenges exist.

Therefore, there is a need for improved techniques that can provide efficient configuration management of distributed applications in a cloud environment.

### SUMMARY

The appended claims may serve as a summary of the invention.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example cloud computing architecture in which embodiments can be used.

FIG. 2 depicts a system diagram for an orchestration system to deploy a distributed application on a computing environment.

FIG. 3A and FIG. 3B illustrate an example of application configuration management.

FIG. 4 depicts a method or algorithm for managing application configuration state with cloud based application management techniques.

FIG. 5 depicts a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

Embodiments are described herein in sections according to the following outline:
1.0 GENERAL OVERVIEW
2.0 STRUCTURAL OVERVIEW
3.0 PROCEDURAL OVERVIEW
4.0 HARDWARE OVERVIEW
5.0 EXTENSIONS AND ALTERNATIVES

### 1.0 General Overview

A system and method are disclosed for managing distributed application configuration state with cloud based application management techniques.

In an embodiment, a computer-implemented method is presented for updating a configuration of a deployed application, the deployed application comprising a plurality of instances each comprising one or more physical computers or one or more virtualized computing devices, in a computing environment, the method comprising: receiving a request to update an application profile model that is hosted in a database, the request specifying a change of a first set of application configuration parameters of the deployed application to a second set of application configuration parameters, the first set of application configuration parameters indicating a current configuration state of the deployed application and the second set of application configuration parameters indicating a target configuration state of the deployed application, in response to the request, updating the application profile model in the database using the second set of application configuration parameters, and generating, based on the updated application profile model, a solution descriptor comprising a description of the first set of application configuration parameters and the second set of application configuration parameters, and updating the deployed application based on the solution descriptor.

In some embodiments, the application configuration parameters are configurable in deployed applications but are not configurable as part of an argument to instantiate an application. The deployed application comprises a plurality of separately executing instances of a distributed firewall application, each instance having been deployed with a copy of a plurality of different policy rules. In other embodiments, updating the deployed application based on the solution descriptor includes: determining a delta parameter set by determining a difference between the first set of application configuration parameters and the second set of application configuration parameters; updating the deployed application based on the delta parameter set.

In various embodiments, in response to updating the application profile model, updating an application solution model associated with the application profile model; in response to updating the application solution model, compiling the application solution model to create the solution descriptor.

In various embodiments, updating the deployed application includes: restarting one or more application components of the deployed application and including the second set second of applications parameters with the restarted one or more application components. wherein updating the deployed application includes: updating the deployed application to include the second set second of application parameters. In an embodiment, each of the application profile model and the solution descriptor comprising a markup language file. In another embodiment, updating the application involves simply providing the second parameter set to the running application.

### 2.0 Structural Overview

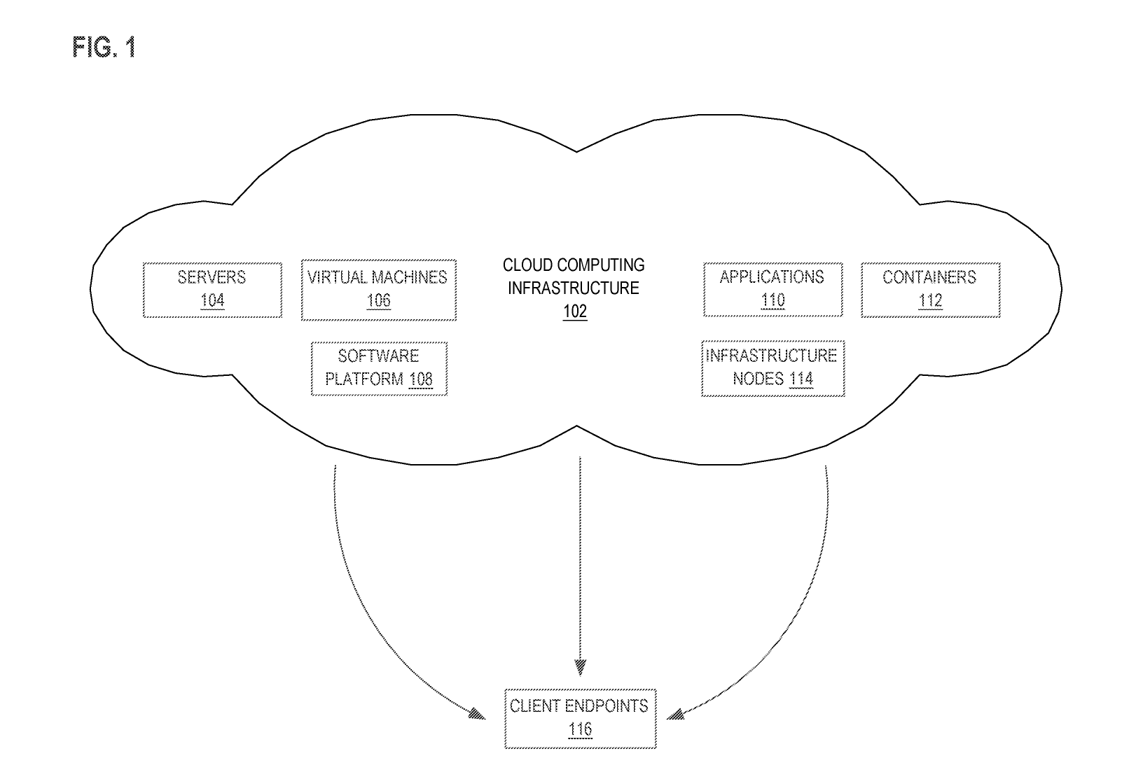

FIG. 1 illustrates an example cloud computing architecture in which embodiments may be used.

In one particular embodiment, a cloud computing infrastructure environment 102 comprises one or more private clouds, public clouds, and/or hybrid clouds. Each cloud comprises a set of networked computers, internetworking devices such as switches and routers, and peripherals such as storage that interoperate to provide a reconfigurable, flexible distributed multi-computer system that can be implemented as a virtual computing center. The cloud environment 102 may include any number and type of server computers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud environment 102 may provide various cloud computing services via cloud elements 104-114 to one or more client endpoints 116 of the cloud environment. For example, the cloud environment 102 may provide software as a service (SaaS) (for example, collaboration services, email services, enterprise resource planning services, content services, communication services, etc.), infrastructure as a service (IaaS) (for example, security services, networking services, systems management services, etc.), platform as a service (PaaS) (for example, web services, streaming services, application development services, etc.), function as a service (FaaS), and other types of services such as desktop as a service (DaaS), information technology management as a service (ITaaS), managed software as a service (MSaaS), mobile backend as a service (MBaaS), etc.

Client endpoints 116 are computers or peripherals that connect with the cloud environment 102 to obtain one or more specific services from the cloud environment 102. For example, client endpoints 116 communicate with cloud elements 104-114 via one or more public networks (for example, Internet), private networks, and/or hybrid networks (for example, virtual private network). The client endpoints 116 can include any device with networking capabilities, such as a laptop computer, a tablet computer, a server, a desktop computer, a smartphone, a network device (for example, an access point, a router, a switch, etc.), a smart television, a smart car, a sensor, a Global Positioning System (GPS) device, a game system, a smart wearable object (for example, smartwatch, etc.), a consumer object (for example, Internet refrigerator, smart lighting system, etc.), a city or transportation system (for example, traffic control, toll collection system, etc.), an internet of things (IoT) device, a camera, a network printer, a transportation system (for example, airplane, train, motorcycle, boat, etc.), or any smart or connected object (for example, smart home, smart building, smart retail, smart glasses, etc.), and so forth.

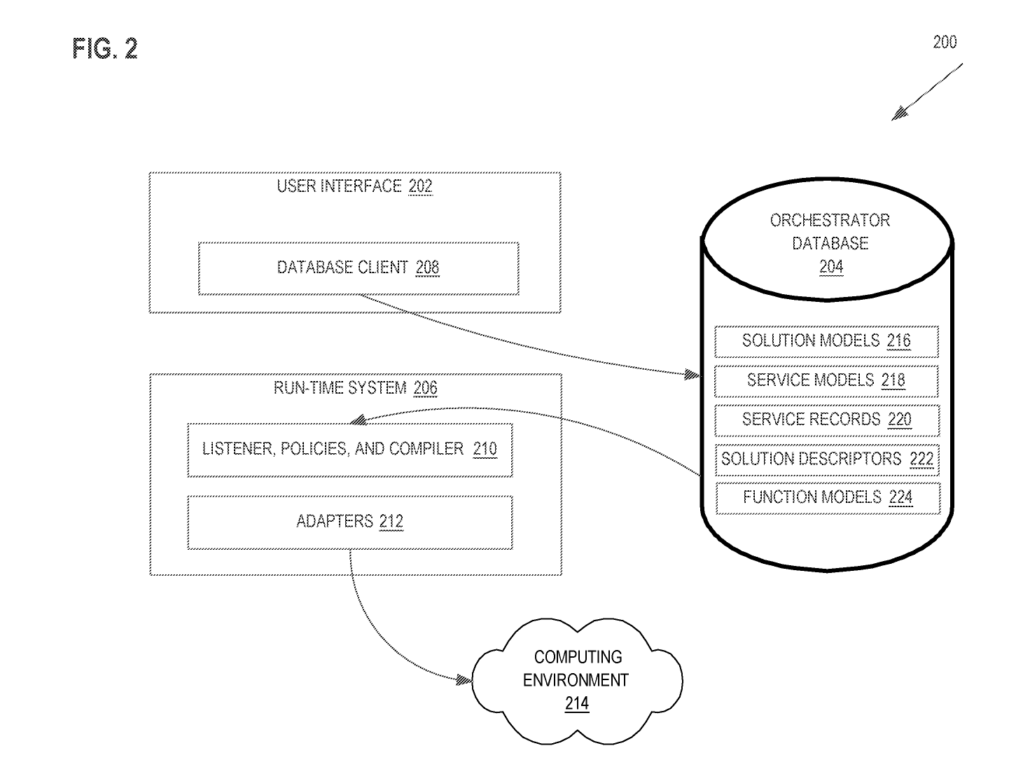

To instantiate applications, services, virtual machines, and the like on the cloud environment 102, some environments may utilize an orchestration system to manage the deployment of such applications or services. For example, FIG. 2 is a system diagram for an orchestration system 200 for deploying a distributed application on a computing environment, such as a cloud environment 102 like that of FIG. 1. In general, the orchestrator system 200 automatically selects services, resources, and environments for deployment of an application based on a request received at the orchestrator. Once selected, the orchestrator system 200 may communicate with the cloud environment 102 to reserve one or more resources and deploy the application on the cloud.

In one implementation, the orchestrator system 200 may include a user interface 202, a orchestrator database 204, and a run-time application or run-time system 206. For example, a management system associated with an enterprise network or an administrator of the network may utilize a computing device to access the user interface 202. Through the user interface 202 information concerning one or more distributed applications or services may be received and/or displayed. For example, a network administrator may access the user interface 202 to provide specifications or other instructions to install, instantiate, or configure an application or service on the computing environment 214. The user interface 202 may also be used to post solution models describing distributed applications with the services (for example, clouds and cloud-management systems) into the computing environment 214. The user interface 202 further may provide active application/service feedback by representing application state managed by the database.

The user interface 202 communicates with a orchestrator database 204 through a database client 208 executed by the user interface. In general, the orchestrator database 204 stores any number and kind of data utilized by the orchestrator system 200, such as service models 218, solution models 216, function models 224, solution descriptors 222, and service records 220. Such models and descriptors are further discussed herein. In one embodiment, the orchestrator database 204 operates as a service bus between the various components of the orchestrator system 200 such that both the user interface 202 and the run-time system 206 are in communication with the orchestrator database 204 to both provide information and retrieve stored information.

Multi-cloud meta-orchestration systems (such as orchestrator system 200) may enable architects of distributed applications to model their applications by way of application's abstract elements or specifications. In general, an architect selects functional components from a library of available abstract elements, or function models 224, defines how these function models 224 interact, and specifies the infrastructure services or instantiated function models or functions that are used to support the distributed application. A function model 224 may include an Application Programming Interface (API), a reference to one or more instances of the function, and a description of the arguments of the instance. A function may be a container, virtual machine, a physical computer, a server-less function, cloud service, decomposed application and the like. The architect may thus craft an end-to-end distributed application comprised of a series of functional models 224 and functions, the combination of which is referred to herein as a solution model 216. A service model 218 may include strongly typed definitions of APIs to help support other models such as function models 224 and solution models 216.

In an embodiment, modeling is based on markup languages such as YAML Ain′t Markup Language (YAML), which is a human-readable data serialization language. Other markup languagues such as XML or Yang may also be used to describe such models. Applications, services and even policies are described by such models.

Operations in the orchestrator are generally intent or promise-based such that models describe what should happen, not necessarily how the models are realized with containers, VMs, etc. This means that when an application architect defines the series of models describing the functional models 224 of the application of the solution model 216, the orchestrator system 200 and its adapters 212 convert or instantiate the solution model 216 into actions on the underlying (cloud and/or data-center) services. Thus, when a high-level solution model 216 is posted into the orchestrator database 204, the orchestrator listener, policies, and compiler 210 may first translate the solution model into a lower-level and executable solution descriptor—a series of data structures describing what occurs across a series of cloud services to realize the distributed application. It is the role of the compiler 210 to thus disambiguate the solution model 216 into the model's descriptor.

To support application configuration management through orchestrator system 200, application service models are included as a subset of service models 218. Application service models are similar to any other service model 218 in orchestrator system 200 and specifically describe configuration methods, such as the API and related functions and methods used to perform application configuration management such as REST, Netconf, Restconf, and others. When these configuration services are included in application function models, the API methods are associated with a particular application. Additionally, application profile models are included as a subset of function models 224. Application profile models model application configuration states and consume the newly defined configuration services from an instance of an application function. For example, an application profile model accepts input from user interface 202. The input may comprise day-N configuration parameters, as discussed below. This combination of application service models and application profile models enables a deployed application to becomes a configurable service akin to other services in orchestrator system 200.

A solution descriptor 222 may include day-N configuration parameters, also referred to herein as “application configuration parameters”. Day-N configuration parameters include all configuration parameters that need to be set in active applications and are not part of arguments required to start or instantiate applications. Day-N configuration parameters define the state of a deployed application. Examples of day-N configuration state include: an application used in a professional media studio may need configuration to tell it how to transcode a media stream, a cloud-based firewall may need policy rules to configure its firewall behavior and allow and deny certain flows, a router needs routing rules that describe where to send IP packets, and a line-termination function such as a mobile packet core may need parameters to load charging rules. An update to the day-N configuration parameters of an application results in a change of configuration state, or a change of day-N configuration state for the application. For example, an update to day-N configuration parameters may excite when a fireall application needs to be started in a different mode or when a media application's command line parameters change.

An operator of an orchestrator can activate a solution descriptor 222. When doing so, functional models 224 as described by their descriptors are activated onto the underlying functions or cloud services and adapters 212 translate the descriptor into actions on physical or virtual cloud services. Service types, by their function, are linked to the orchestrator system 200 by way of an adapter 212 or adapter model. In this manner, adapter models (also referred to herein as “adapters”) may be compiled in a similar manner as described above for solution models. As an example, to start a generic program bar on a specific cloud, say, the foo cloud, the foo adapter 212 or adapter model takes what is written in the descriptor citing foo and translates the descriptor towards the foo API. As another example, if a program bar is a multi-cloud application, say, a foo and bletch cloud, both foo and bletch adapters 212 are used to deploy the application onto both clouds.

Adapters 212 also play a role in adapting deployed applications from one state to the next. As models for active descriptors are recompiled, it is up to the adapters 212 to morph the application space to the expected next state. This may include restarting application components, cancelling components altogether, or starting new versions of existing applications components. This also may include updating a deployed application by restarting one or more application components of the deployed application and including an updated set of applications parameters with the restarted one or more application components. In other words, the descriptor describes the desired end-state which activates the adapters 212 to adapt service deployments to this state, as per intent-based operations.

An adapter 212 for a cloud service may also posts information back into the orchestrator database 204 for use by the orchestrator system 200. In particular, the orchestrator system 200 can use this information in the orchestrator database 204 in a feedback loop and/or graphically represent the state of the orchestrator managed application. Such feedback may include CPU usage, memory usage, bandwidth usage, allocation to physical elements, latency and, if known, application-specific performance details based on the configuration pushed into the application. This feedback is captured in service records. Records may also be cited in the solution descriptors for correlation purposes. The orchestrator system 200 may then use record information to dynamically update the deployed application in case it does not meet the required performance objectives.

Deployment and management of distributed applications and services in context of the above described systems is further discussed in U.S. patent application Ser. No. 15/899,179, filed Feb. 19, 2018, the entire contents herein incorporated by reference.

As discussed in the above referenced application, the above discussed modeling captures the operational interface to a function as a data structure as captured by a solution descriptor 222. Further, the orchestration system provides an adapter framework that adapts the solution descriptor 222 to whatever underlying methods are needed to interface to that function. For instance, to interface to a containerization management system such as DOCKER or KUBERNETES, an adapter consumes a solution descriptor 22 and translates that model to the API offered by the containerization management system. The orchestrator does this for all its services, including, but not limited to statistics and analytics engines, on-prem and public cloud offerings, applications such as media applications or firewalls and more. Adapters 212 can be written in any programming language; their only requirement is that these adapters 212 react to the modeling data structures posted to the enterprise message bus and that these provide feedback of the deployment by way of service-record data structures onto the enterprise message bus.

### 3.0 Procedural Overview

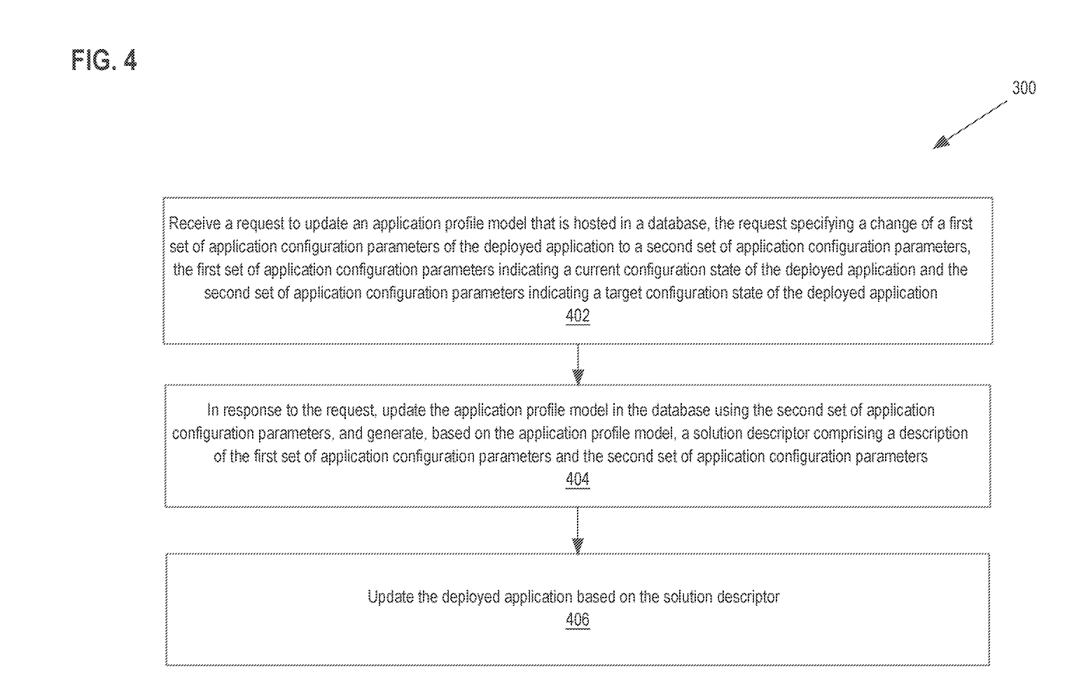

FIG. 4 depicts a method or algorithm for managing application configuration state with cloud based application management techniques. FIG. 4 is described at the same level of detail that is ordinarily used, by persons of skill in the art to which this disclosure pertains, to communicate among themselves about algorithms, plans, or specifications for other programs in the same technical field. While the algorithm or method of FIG. 4 shows a plurality of steps providing authentication, authorization, and accounting in a managed system, the algorithm or method described herein may be performed using any combination of one or more steps of FIG. 4 in any order, unless otherwise specified.

For purposes of illustrating a clear example, FIG. 4 is described herein in the context of FIG. 1 and FIG. 2, but the broad principles of FIG. 4 can be applied to other systems having configurations other than as shown in FIG. 1 and FIG. 2. Further, FIG. 4 and each other flow diagram herein illustrates an algorithm or plan that may be used as a basis for programming one or more of the functional modules of FIG. 2 that relate to the functions that are illustrated in the diagram, using a programming development environment or programming language that is deemed suitable for the task. Thus, FIG. 4 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

In an embodiment, FIG. 4 represents a computer-implemented method for updating a configuration of a deployed application in a computing environment. The deployed application comprises a plurality of instances each comprising one or more physical computers or one or more virtualized computing devices. In an embodiment, the deployed application comprises a distributed application.

In an embodiment, the deployed application comprises a plurality of separately executing instances of a distributed firewall application, each instance having been deployed with a copy of a plurality of different policy rules.

At step 402, a request is received to update an application profile model that is hosted in a database. The request specifies a change of a first set of application configuration parameters of the deployed application to a second set of application configuration parameters. The first set of application configuration parameters indicates a current configuration state of the deployed application and the second set of application configuration parameters indicates a target configuration state of the deployed application.

For example, a client issues a request to update an application profile model through user interface 202. The request to update the application profile model may be specified in a markup language such as YAML. The request may include application configuration parameters such as the first set of application configuration parameters that indicate a current configuration state of the deployed application and the second set of application configuration parameters that indicate a target configuration state of the deployed application.

In another embodiment, the request may include the second set of application configuration parameters. The second set of application configuration parameters may themselves indicate a change of the first set of application configuration parameters to a second set of application configuration parameters.

In an embodiment, application configuration parameters are configurable in deployed applications but are not configurable as part of an argument to instantiate an application.

At step 404, in response to the request received in step 402, the application profile model is updated in the database using the second set of application configuration parameters. A solution descriptor is generated based on the updated application profile model. The solution descriptor comprises a description of the first set of application configuration parameters and the second set of application configuration parameters. For example, the database client 208 updates the application profile model in orchestrator database 204. The application profile model may be included as a subset of function models 224.

In an embodiment, in response to updating the application profile model, an application solution model associated with the application profile model is updated by the orchestrator system 200. The application solution model may be included as a subset of solution models 216 in orchestrator database 204. In response to updating the application solution model, the run-time system 206 compiles the application solution model using the compiler 210 to generate the solution descriptor.

In an embodiment, the solution descriptor includes the first set of application configuration parameters and the second set of application configuration parameters. An adapter 212 then receives the solution descriptor and determines a delta parameter set by determining a difference between the first set of application configuration parameters and the second set of application configuration parameters.

In another embodiment, the solution descriptor includes the second set of application configuration parameters and an other solution descriptor includes the first set of application parameters.

At step 406, the deployed application is updated based on the solution descriptor. For example, the adapter 212 updates the deployed application by translating the solution descriptor into actions on physical or virtual cloud services.

In an embodiment, the deployed application is updated based on the delta parameter set discussed in step 404.

In an embodiment, updating the deployed application includes restarting one or more application components of the deployed application and including the second set second of applications parameters with the restarted one or more application components. In another embodiment, updating the deployed application includes updating the deployed application to include the second set second of application parameters.

As described herein, once the deployed application is updated with the second set of configuration parameters, an adapter 212 for a cloud service may post service records into the orchestrator database 204 for use by the orchestrator system 200 describing the state of the deployed application. The state of the deployed application may include at least one metric defining: CPU usage, memory usage, bandwidth usage, allocation to physical elements, latency or application-specific performance details and possibly the configuration enforced upon the application. The service record posted to the orchestrator database 204 may be paired to the solution descriptor that caused the creation of the service record. Such service record updates can then be used for feedback loops and policy enforcement.

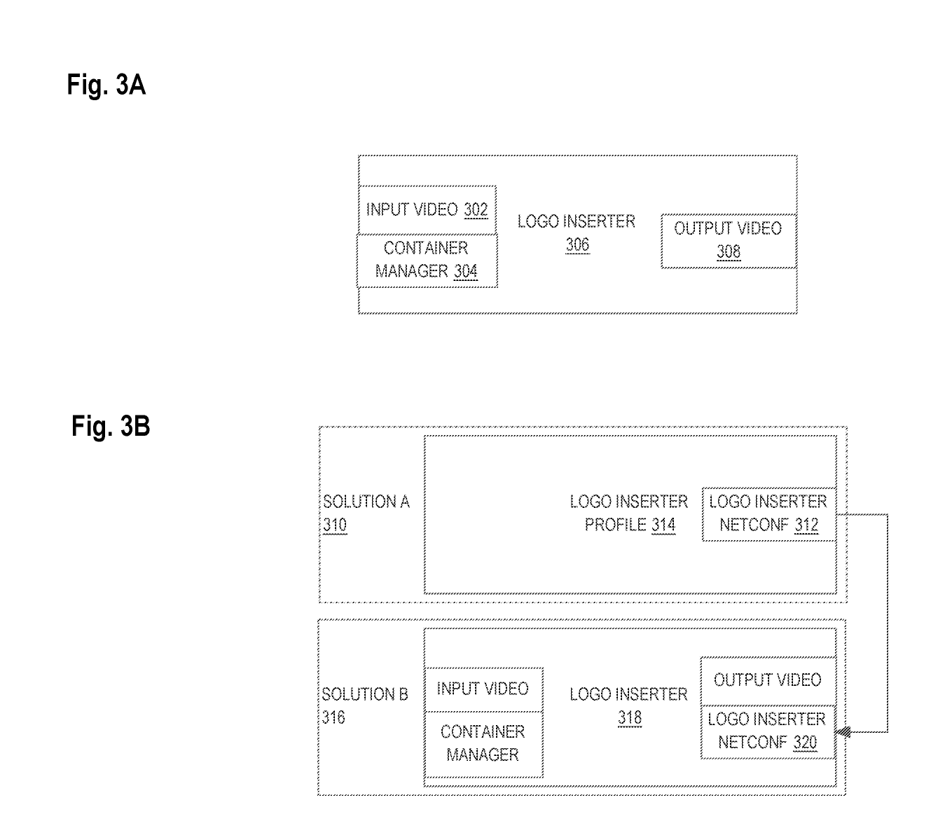

FIG. 3A illustrates an example of application configuration management. Consider a media application that can be deployed as a Kubernetes (k8s) managed pod with a container and is able to receive a video signal as input, overlay a logo on such signal, and produce the result as output. This application logo inserter 306 can be modelled by a function model that, as depicted by function models 224 in FIG. 2, (1) consumes a video service instance of a service model associated with the specific input video 302 format and transport mechanism, (2) consumes a k8s service 304 instance of a k8s service model associated with the k8s API, and (3) provides a video service instance of a service model associated with the specific output video 308 format and transport mechanism.

Assume further that the media application offers the ability to configure the size of the logo overlay. Such configuration can be provided as day-0 configuration parameters as part of the k8s service consumption, for example as a container environment variable, and modeled in the associated consumer service model.

For the purposes of this example, however, the application may provide a day-N configuration mechanism, such as one based on Netconf/Yang, REST or a proprietary programming mechanism. The same modelling mechanism may be used to capture this, in particular:

A provider and a consumer service model are defined that define a generic Yang configuration. Yang models are extended with a pair of specific “logo inserter” Netconf service models 312, 320. This captures the specific day-N configuration that the logo inserter application accepts. In this example, it holds the Yang model that includes the size of the logo. The logo inserter 318 function model is updated by adding a new provided service of type “logo inserter Netconf” 320. Another function is defined for the logo inserter profile 314 that consumes the “logo inserter Netconf” 312 and holds the actual application configuration, such as the specific logo size. Finally, the two functions are deployed in separate solution models A 310, and B 316, and connected as illustrated in FIG. 3B. The connection of the solution models ensures that the application configuration is applied to the logo-insertion function only when the latter (and thus its solution) is “up”.

When the solution A 310 is activated, a Netconf/Yang adapter reads the actual logo size specified in the logo inserter profile 314 function and pushes it to the logo inserter 318 function via Netconf to the application. The same adapter can retrieve the Netconf/Yang operational state of the logo inserter and make it available in a service record.

Subsequent updates to the logo inserter profile 314 instance in solution A 310 trigger the Netconf adapter to reconfigure the logo inserter 318 with the updated configurations. By way of enforcement, updates to the logo inserter profile 314 lead to recompiled solution models, updated solution descriptors and the application configuration adapter updating the deployed applications.

As with all modeling and promise-/intent-based operations, the validity and consistency of the deployed application set may be tested periodically. Given that the application profile is part of the standard modeling, configuration parameters are tested periodically. This means that if an application crashed and was restarted by a cloud system, the appropriate application profile is automatically pushed into the application instance. Techniques described herein are applicable to physical, virtual or cloudified applications.

There are numerous advantages to the methods and algorithms described herein. Generally, the methods and algorithms help organize all the modeling and enforcement for distributed application deployment. Through a single data set and descriptions, all part of the application life-cycle of a distributed application can be managed by way of such an orchestration system. This results in improved and more efficient use of computer hardware and software, which uses less computing power and/or memory, and allows for faster management of application deployments. This is a direct improvement to the functionality of a computer system, and one that enables the computer system to perform tasks that the system was previously unable to perform and/or to perform tasks faster and more efficiently that was previously possible.

### 4.0 Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

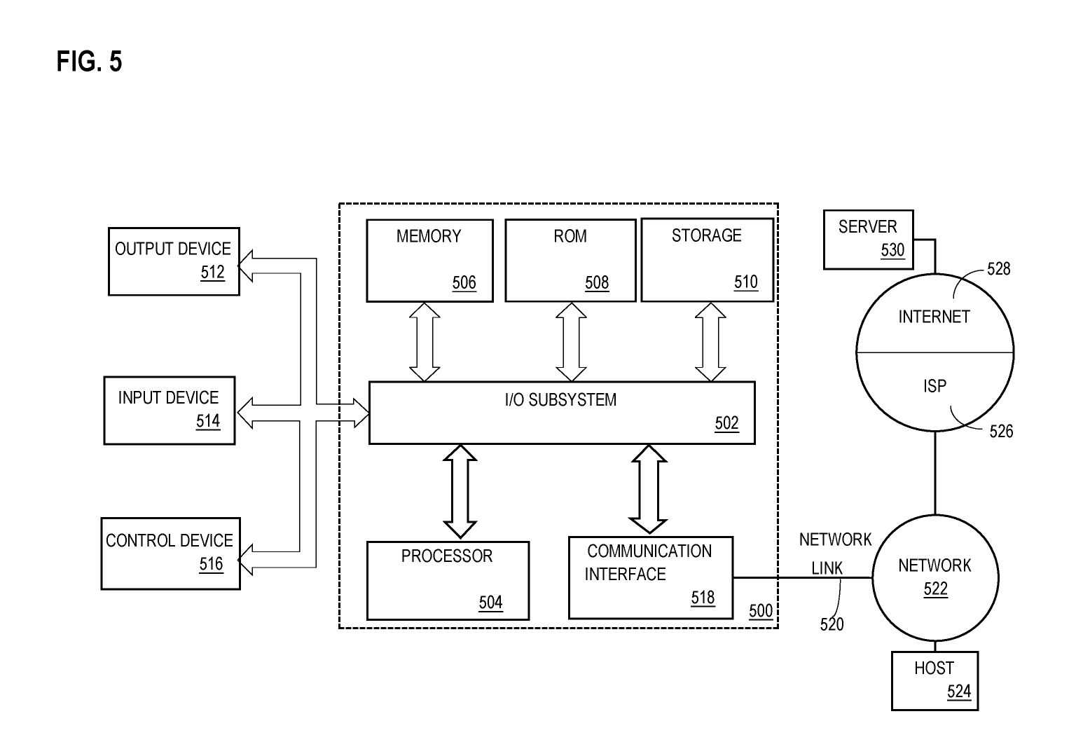

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk or optical disk such as CD-ROM or DVD-ROM and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on display 512. The input device may have at least two degrees of freedom in two axes, a first axis (for example, x) and a second axis (for example, y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware and interfaces for generating position reporting packets, notifications, pulse or heartbeat signals, or other recurring data transmissions that specify a position of the computer system 500, alone or in combination with other application-specific data, directed toward host 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to bus 502. Communication interface 518 provides a two-way data communication coupling to network link(s) 520 that are directly or indirectly connected to at least one communication networks, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a local area network (LAN), wide-area network (WAN), campus network, internetwork or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server computer 530 may be coupled to internet 528. Server 530 broadly represents any computer, data center, virtual machine or virtual computing instance with or without a hypervisor, or computer executing a containerized program system such as VMWARE, [etc etc] DOCKER or KUBERNETES. Server 530 may represent an electronic digital service that is implemented using more than one computer or instance and that is accessed and used by transmitting web services requests, uniform resource locator (URL) strings with parameters in HTTP payloads, API calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or no SQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 5.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method for updating a configuration of a deployed application, the deployed application comprising a plurality of instances each comprising one or more physical computers or one or more virtualized computing devices, in a computing environment, the method comprising:
receiving a request to update an application profile model that is hosted in a database, the request specifying a change of a first set of application configuration parameters of the deployed application to a second set of application configuration parameters, the first set of application configuration parameters indicating a current configuration state of the deployed application and the second set of application configuration parameters indicating a target configuration state of the deployed application;
in response to the request, updating the application profile model in the database using the second set of application configuration parameters, and generating, based on the updated application profile model, a solution descriptor comprising a description of the first set of application configuration parameters and the second set of application configuration parameters; and
updating the deployed application based on the solution descriptor.

2. The method of claim 1, wherein the application configuration parameters are configurable in deployed applications but are not configurable as part of an argument to instantiate an application.

3. The method of claim 1, wherein the deployed application comprises a plurality of separately executing instances of a distributed firewall application, each instance having been deployed with a copy of a plurality of different policy rules.

4. The method of claim 1, wherein updating the deployed application based on the solution descriptor includes:
determining a delta parameter set by determining a difference between the first set of application configuration parameters and the second set of application configuration parameters; and
updating the deployed application based on the delta parameter set.

5. The method of claim 1, further comprising:
in response to updating the application profile model, updating an application solution model associated with the application profile model; and
in response to updating the application solution model, compiling the application solution model to create the solution descriptor.

6. The method of claim 1, wherein updating the deployed application includes: restarting one or more application components of the deployed application and including the second set second of applications parameters with the restarted one or more application components.

7. The method of claim 1, wherein updating the deployed application includes: updating the deployed application to include the second set second of application parameters.

8. The method of claim 1, further comprising:
receiving an application service record describing the state of the deployed application.
pairing the application service record to the solution descriptor.

9. The method of claim 8, wherein the state of the deployed applications includes at least one metric defining: CPU usage, memory usage, bandwidth usage, allocation to physical elements, latency or application-specific performance details or application-specific state.

10. The method of claim 1, each of the application profile model and the solution descriptor comprising a markup language file.

11. A computer system for updating a configuration of a deployed application, the deployed application comprising a plurality of instances each comprising one or more physical computers or one or more virtualized computing devices, in a computing environment comprising:
one or more processors;
an orchestrator of the computing environment configured to:
receive a request to update an application profile model that is hosted in a database, the request specifying a change of a first set of application configuration parameters of the deployed application to a second set of application configuration parameters, the first set of application configuration parameters indicating a current configuration state of the deployed application and the second set of application configuration parameters indicating a target configuration state of the deployed application;
in response to the request, update the application profile model in the database using the second set of application configuration parameters, and generate, based on the updated application profile model, a solution descriptor comprising a description of the first set of application configuration parameters and the second set of application configuration parameters; and
update the deployed application based on the solution descriptor.

12. The computer system of claim 11, wherein the application configuration parameters are configurable in deployed applications but are not configurable as part of an argument to instantiate an application.

13. The computer system of claim 11, wherein the deployed application comprises a plurality of separately executing instances of a distributed firewall application, each instance having been deployed with a copy of a plurality of different policy rules.

14. The computer system of claim 11, wherein updating the deployed application based on the solution descriptor includes:
determining a delta parameter set by determining a difference between the first set of application configuration parameters and the second set of application configuration parameters; and
updating the deployed application based on the delta parameter set.

15. The computer system of claim 11, further comprising:
in response to updating the application profile model, updating an application solution model associated with the application profile model; and
in response to updating the application solution model, compiling the application solution model to create the solution descriptor.

16. The computer system of claim 11, wherein updating the deployed application includes: restarting one or more application components of the deployed application and including the second set second of applications parameters with the restarted one or more application components.

17. The computer system of claim 11, wherein updating the deployed application includes: updating the deployed application to include the second set second of application parameters.

18. The computer system of claim 11, further comprising:
receiving an application service record describing the state of the deployed application.
pairing the application service record to the solution descriptor.

19. The computer system of claim 18, wherein the state of the deployed applications includes at least one metric defining: CPU usage, memory usage, bandwidth usage, allocation to physical elements, latency or application-specific performance details.

20. The computer system of claim 11, each of the application profile model and the solution descriptor comprising a markup language file.
